(19) United States
(12) Patent Application Publication
(10) Pub. No.: US 2025/0215335 A1
(43) Pub. Date: Jul. 3, 2025

(54) PROCESS FOR STABLE BLEND OF POLYSTYRENE PLASTIC WITH HYDROCARBON FEED FOR FEEDING TO OIL REFINERY UNITS AND PROCESS OF PREPARING SAME

(71) Applicant: Chevron U.S.A. Inc., San Ramon, CA (US)

(72) Inventors: Hye-Kyung Cho TIMKEN, Albany, CA (US); Tengfei LIU, San Ramon, CA (US); Joel E. SCHMIDT, San Ramon, CA (US)

(73) Assignee: Chevron U.S.A. Inc., San Ramon, CA (US)

(21) Appl. No.: 18/999,075

(22) Filed: Dec. 23, 2024

Related U.S. Application Data
(60) Provisional application No. 63/615,360, filed on Dec. 28, 2023.

(51) Int. Cl. C10G 47/30

(52) U.S. Cl. CPC C10G 47/30; C10G 2300/1003; C10G 2300/1044; C10G 2300/1096

(57) ABSTRACT

Provided is a composition comprising a blend of polystyrene and an aromatic-rich hydrocarbon feedstock. Also provided is a process for preparing a stable blend of polystyrene and an aromatic-rich hydrocarbon feedstock which can be stored or transported if desired. In one embodiment, the aromatic-rich hydrocarbon feedstock comprises light cycle oil, heavy gasoline, heavy reformate, an aromatic solvent, or a mixture thereof. The amount of polystyrene in the blend comprises no more than 20 wt. % of the blend. The blend can be passed to a conversion unit for conversion of the polystyrene.

### CROSS REFERENCE TO RELATED APPLICATIONS

The present application claims priority to U.S. Provisional Application No. 63/615,360 filed Dec. 28, 2023, the complete disclosure of which is incorporated herein by reference in its entirety.

### BACKGROUND

The world has seen extremely rapid growth of plastics production. According to PlasticEurope Market Research Group, the world's plastics production was 335 million tons in 2016, 348 million tons in 2017 and 359 million tons in 2018. According to Mckinsey & Company, the global plastics-waste volume was estimated about 260 million tons per year in 2016 and projected to be 460 million tons per year by 2030 if the current trajectory continues.

Single use plastic waste has become an increasingly important environmental issue. At the moment, there appear to be few options for recycling polyethylene and polypropylene waste plastics to value-added chemicals and fuel products. Currently, only a small amount of polyethylene/polypropylene is recycled via chemical recycling, where recycled and cleaned plastic pellets are pyrolyzed in a pyrolysis unit to make fuels (naphtha, diesel), steam cracker feed or slack wax. The majority, greater than 80%, is incinerated, land filled or discarded.

The current method of the chemical recycling via pyrolysis cannot make a big impact for the plastics industry. The current pyrolysis operation produces poor quality fuel components (naphtha and diesel range products), but the quantity is small enough that these products can be blended into fuel supplies. However, this simple blending cannot continue if we have to recycle very large volumes of waste polyethylene and polypropylene to address the environmental issues. The products as produced from the pyrolysis unit have too poor quality to be blended in large amounts (for example 5-20 volume % blending) in transportation fuels.

Processes are known which convert waste plastic into hydrocarbon lubricants. For example, U.S. Pat. No. 3,845,157 discloses cracking of waste or virgin polyolefins to form gaseous products such as ethylene/olefin copolymers which are further processed to produce synthetic hydrocarbon lubricants. U.S. Pat. No. 4,642,401 discloses the production of liquid hydrocarbons by heating pulverized polyolefin waste at temperatures of 150-500° C. and pressures of 20-300 bars. U.S. Pat. No. 5,849,964 discloses a process in which waste plastic materials are depolymerized into a volatile phase and a liquid phase. The volatile phase is separated into a gaseous phase and a condensate. The liquid phase, the condensate and the gaseous phase are refined into liquid fuel components using standard refining techniques. U.S. Pat. No. 6,143,940 discloses a procedure for converting waste plastics into heavy wax compositions. U.S. Pat. No. 6,150,577 discloses a process of converting waste plastics into lubricating oils. EP0620264 discloses a process for producing lubricating oils from waste or virgin polyolefins by thermally cracking the waste in a fluidized bed to form a waxy product, optionally using a hydrotreatment, then catalytically isomerizing and fractionating to recover a lubricating oil.

U.S. Pub. No. 2021/0130699 discloses processes and systems for making recycle content hydrocarbons from recycled waste material. The recycle waste material is pyrolyzed to form a pyrolysis oil composition, at least a portion of which may then be cracked to form a recycle olefin composition.

Other documents which relate to processes for converting waste plastic into lubricating oils include U.S. Pat. Nos. 6,288,296; 6,774,272; 6,822,126; 7,834,226; 8,088,961; 8,404,912 and 8,696,994; and U.S. Patent Application Publication Nos. 2019/0161683; 2016/0362609; and 2016/0264885. The foregoing patent documents are incorporated herein by reference in their entirety.

Globally, recycling or upcycling of plastic waste has gained great interest to save resources and the environment. Mechanical recycling of plastic waste is rather limited due to different types, properties, additives, and contaminants in the collected plastics. Usually, the recycled plastics are of degraded quality. Chemical recycling to the starting material or value-added chemicals has emerged as a more desirous route.

While plastics such as polyethylene and polypropylene have been the focus of chemical recycling, there are many other waste plastics. Such plastics have been ignored to some extent due to difficulties in chemical recycling. One such waste plastic is polystyrene.

Polystyrene is a high use plastic that finds uses ranging from packaging materials and foams to hard containers. Currently there is little incentive to recycle polystyrene. As the main constituent of polystyrene is an aromatic species it may be beneficial if this can be recovered as styrene to then make circular polystyrene or as another aromatic species that may have higher value than typical plastic pyrolysis products. Indeed, it has been reported that styrene and other aromatic species can be recovered from the pyrolysis of polystyrene.

Pyrolysis of solid plastics is an important technology as it offers a method for dealing with hard to recycle plastics such as polyethylene, polypropylene, and polystyrene. However thermal pyrolysis has some serious downsides such as the formation of high amounts of dry gases, which are used to fuel the pyrolysis process but have no other value, and solid char that needs to be landfilled. Catalytic pyrolysis is a known process which can improve yields of desired products but practicing this process with a solid feed is challenging.

However, in order to achieve chemical recycling of polystyrene plastic in an industrially significant quantity to reduce its environmental impact, more robust processes are needed. Such a process may require unique handing and manipulation of the polystyrene waste plastic.

### SUMMARY

In one embodiment, provided is a composition of a stable blend of a polystyrene plastic and an aromatic-rich hydrocarbon feedstock for direct conversion of the waste plastic in a refinery process unit.

The stable blend comprises a particular aromatic-rich hydrocarbon feedstock and 1-20 weight % of polystyrene plastic. In one embodiment, the aromatic-rich hydrocarbon feedstock comprises light cycle oil (LCO), heavy gasoline, heavy reformate or an aromatic solvent. In one embodiment, the polystyrene plastic in the blend is present as finely dispersed microcrystalline particles having an average particle size of 10 micron to less than 100 microns, preferentially less than 80 microns.

Also provided in one embodiment is a process for preparing a blend of polystyrene plastic and an aromatic-rich hydrocarbon feedstock. The process comprises mixing an aromatic-rich hydrocarbon feed and a polystyrene plastic together, and heating the mixture above the melting point of the plastic, but not greater than 550° F. With continued mixing, the plastic melt and hydrocarbon feedstock liquid blend is cooled to a temperature below the melting point of the plastic.

Among other factors, the present process prepares a stable blend of polystyrene plastic and an aromatic-rich hydrocarbon feedstock. This blend of plastic and aromatic-rich hydrocarbon feedstock provides a vehicle to efficiently and effectively feed waste plastic to refinery processes for conversion of the waste plastic to high volume products, with good yields. It has been found that by preparing the present blend and feeding the blend to refinery operations, one can efficiently and effectively recycle polystyrene plastic waste while also complementing the operation of a refinery in the preparation of higher value products such as gasoline, jet fuel, base oil, and diesel fuel. Polystyrene can also be produced from the waste polystyrene plastic. In fact, positive economics are realized for the overall recycling process with product quality identical to that of virgin polystyrene polymer. The use of the present blend also saves energy and is more environmentally friendly than prior polystyrene recycling processes.

### BRIEF DESCRIPTION OF THE DRAWING

FIG. 1 depicts the current practice of pyrolyzing waste plastics to produce fuel or wax (base case).

FIG. 2 depicts a present process of preparing a hot homogeneous liquid blend of plastic and hydrocarbon feedstock and how the blend can be fed to a refinery conversion unit.

FIG. 3 depicts in detail the stable blend preparation process and how the stable blend can be fed to a refinery conversion unit.

FIG. 4 graphically shows the thermal stability of various plastics, including polystyrene, by Thermal Gravimetric Analysis (TGA) results.

FIG. 5 depicts the plastic type classification for waste plastics recycling.

### DETAILED DESCRIPTION

Provided is a composition comprising a blend of polystyrene and a hydrocarbon feedstock. Also provided is a process for preparing a stable blend of polystyrene and a hydrocarbon feedstock which can be stored or transported if desired. In one embodiment, the aromatic-rich hydrocarbon feedstock comprises light cycle oil, heavy gasoline, heavy reformate, an aromatic solvent, or a mixture thereof. The amount of polystyrene in the blend comprises no more than 20 wt. % of the blend. The blend can be passed to a conversion unit for conversion of the polystyrene.

Disclosed are a novel polystyrene plastic and an aromatic-rich hydrocarbon feedstock blend, and a process to prepare a stable blend of a polystyrene plastic and an aromatic-rich hydrocarbon feedstock for direct conversion of plastic in a refinery process unit. In one embodiment, the aromatic-rich hydrocarbon feedstock comprises light cycle oil (LCO), heavy gasoline, heavy reformate or an aromatic solvent.

In one embodiment, a process is provided for preparing a stable blend of a polystyrene plastic, preferably waste polystyrene plastic, and an aromatic-rich hydrocarbon feedstock for storage, transportation or feeding to a refinery unit. The process comprises first selecting polystyrene plastics, preferably waste polystyrene plastics. These waste polystyrene plastics are then passed through a blend preparation unit to make a stable blend of waste polystyrene plastic and the hydrocarbon feedstock. The aromatic-rich hydrocarbon feedstock generally comprises a LCO, heavy gasoline, heavy reformate or an aromatic solvent. The stable blend can be fed to a refinery conversion unit for direct conversion of waste plastic to value-added chemicals and fuels.

The aromatic-rich hydrocarbon feedstock such as LCO, heavy gasoline, heavy reformate or aromatic solvent is produced from conventional petroleum refinery employing petroleum-based feedstocks. Aromatic-rich hydrocarbon can also be produced from catalytic conversion processes employing biofeedstocks. After the oxygen in biofeedstock has been removed by catalysts, the liquid products are mostly hydrocarbons with high aromatic contents.

The aromatics in the aromatic-rich hydrocarbon feedstock can comprise from 50 wt. % to 99 wt. % of the hydrocarbon feedstock, and generally comprises 1-ring, 2-ring and 3-ring aromatics. More preferably, the aromatic-rich hydrocarbon feedstock comprises 75 wt. % and higher of 1-ring, 2-ring and 3-ring aromatics.

The stable blend is made by a two-step process. The first step produces a hot, homogeneous liquid blend of polystyrene plastic melt with hydrocarbon feedstock. The preferred range of the plastic composition in the blend is about 1-20 wt. %, 1-10 wt. % in one embodiment and from 1-5 wt. % in another embodiment. The preferred conditions for the hot liquid blend preparation include heating of polystyrene plastic above the melting point of the plastic while vigorously mixing with the aromatic-rich hydrocarbon feedstock, which can comprise LCO, heavy gasoline, heavy reformate and/or an aromatic solvent. The preferred process conditions include heating to a 250-550° F. (120-290° C.) temperature, a residence time of 5-240 minutes at the final heating temperature, and 0-10 psig atmospheric pressure. This can be done in the open atmosphere as well as preferably under an oxygen-free inert atmosphere.

In the second step, the hot blend is cooled down below the melting point of the plastic while continuously, vigorously mixing, and then further cooling down to a lower temperature, preferably an ambient temperature, to produce a stable blend. The stable blend is either an oily liquid or in a waxy solid state at the ambient temperature depending on the hydrocarbon feedstock.

In one embodiment, the stable blend is made of the hydrocarbon feedstock and 1-20 wt. % of waste polystyrene plastic, wherein the polystyrene plastic is in the form of finely dispersed micron-size particles with 10 micron to less than 100-microns average particle size.

There are several advantages realized by the present blend and its use. For example, the stable blend of polystyrene plastic and aromatic-rich hydrocarbon feedstock can be stored at ambient temperature and pressure for extended time periods. During the storage, no agglomeration, no settling of polymer particles and no chemical/physical degradation of the blend are observed. This allows easier handling of the waste plastic material for storage or transportation.

The stable blend can be handled easily by using standard pumps as are typically used in refineries or warehouses, or by using pumps equipped with transportation tanks. Depending on the blend, some heating of the blend above its pour point is required to pump the blend for transfer or for feeding to a conversion unit in a refinery. During the heating, no agglomeration of polystyrene polymer is observed.

For feeding to a refinery unit, the stable blend can be further heated above the melting point of the polystyrene plastic to produce a homogeneous liquid blend of hydrocarbon and polystyrene plastic. The hot homogeneous liquid blend is fed directly to the oil refinery process units for conversion of waste polystyrene plastics to high value products with good yields.

Refinery conversion units such as a fluid catalytic cracking (FCC) unit, hydrocracking unit, and hydrotreating unit, convert the hot homogeneous liquid blend of the polystyrene plastic and hydrocarbon feedstock in the presence of catalysts with simultaneous conversion of the polystyrene plastic and hydrocarbon feedstock. The presence of catalysts in the conversion unit allows conversion of the waste plastics to higher value products at a lower operating temperature than the typical pyrolysis temperature. The yields of undesirable byproducts (offgas, tars, coke) are lower than the typical pyrolysis process. For the hydroprocessing units (hydrocracking and hydrotreating units), hydrogen is added to units to improve the conversion of the polystyrene plastics. The blend may generate additional synergistic benefits coming from the interaction of the plastic and hydrocarbon feedstock during the conversion process. Fluid catalytic cracking and hydrocracking processes are preferred modes of catalytic conversion of the stable blend.

In one embodiment, the stable blend of polystyrene plastic and hydrocarbon feedstock can be sent to a coker unit for thermal conversion of waste polystyrene plastics. In this case, there are no substantial advantages in the reactor temperature or the product yield compared to a pyrolysis process. The advantage of the coker unit is its feed flexibility in that the unit can handle a blend with very high nitrogen, sulfur, and metals impurities.

The stable blend of polystyrene plastic and hydrocarbon feedstock allows more efficient recycling of waste polystyrene plastics. The use of the present blend is far more energy efficient than the current pyrolysis process, and allows recycling with a lower carbon footprint. The improved processes would allow establishment of a circular economy on a much larger scale by efficiently converting waste polystyrene plastics back to virgin quality polymers or value-added chemicals and fuels.

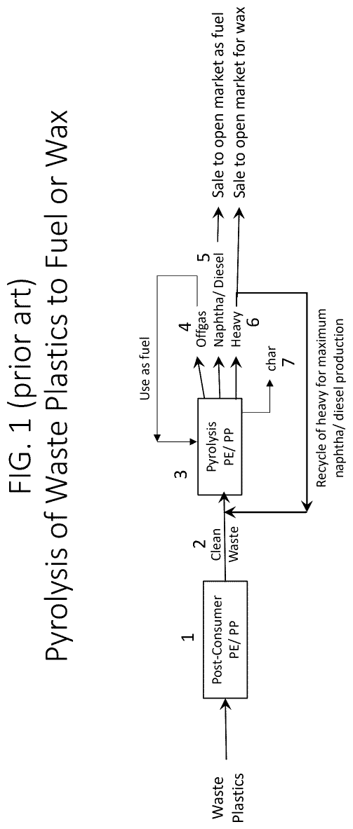

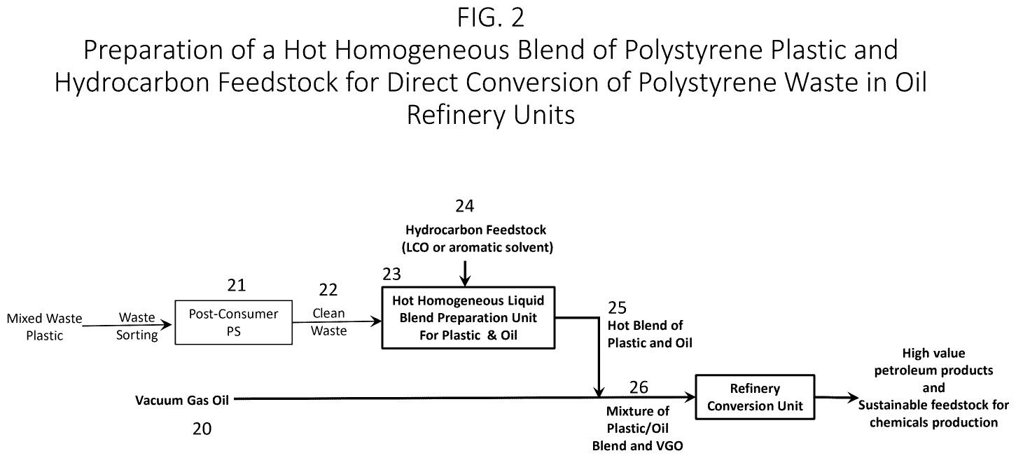

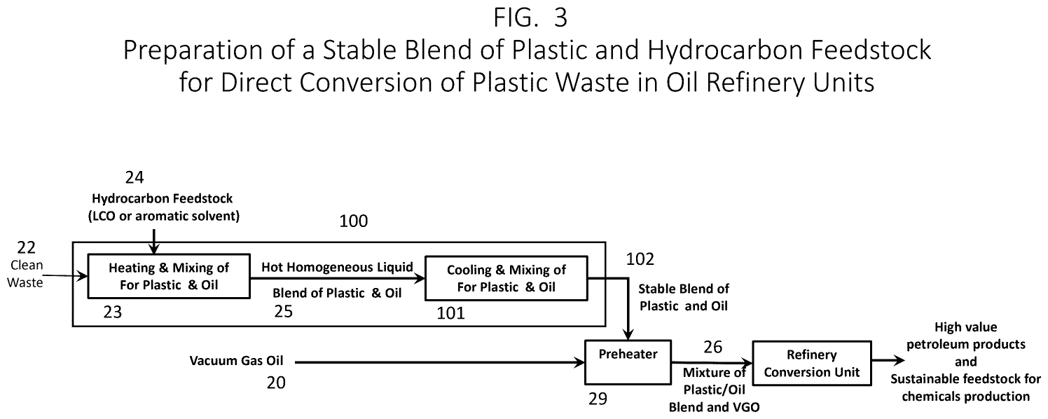

A simplified process diagram for a base case of a waste plastics pyrolysis process is shown in FIG. 1. Preparation of a hot homogeneous liquid blend of polystyrene plastic and aromatic-rich hydrocarbon feedstock is shown in FIG. 2. FIG. 3 depicts in detail the preparation of a stable blend of waste plastic and hydrocarbon feedstock. The figures depict the two process steps associated with the blend preparation.

As noted above, FIG. 1 shows a diagram of the pyrolysis of waste plastics fuel or wax that is generally operated in the industry today. Generally, the waste plastics are sorted together 1. The cleaned plastic waste 2 is converted in a pyrolysis unit 3 to offgas 4 and pyrolysis oil (liquid product). The offgas 4 from the pyrolysis unit 3 is used as fuel to operate the pyrolysis unit. An on-site distillation unit separates the pyrolysis oil to produce naphtha and diesel 5 products which are sold to fuel markets. The heavy pyrolysis oil fraction 6 is recycled back to the pyrolysis unit 3 to maximize the fuel yield. Char 7 is removed from the pyrolysis unit 3. The heavy fraction 6 is rich in long chain, linear hydrocarbons, and is very waxy (i.e., forms paraffinic wax upon cooling to ambient temperature). Wax can be separated from the heavy fraction 6 and sold to the wax markets.

Use of the present blend, however, avoids the pyrolysis of the waste plastic. Rather, a stable blend of hydrocarbon feedstock and the polystyrene plastic is prepared, which can be fed to the refinery units. Thus, the pyrolysis step can be avoided, which is a significant energy savings.

The present blend is prepared in a hot blend preparation unit where the operating temperature is above the melting point of the polystyrene plastic (about 200-290° C.), to make a hot homogeneous liquid blend of polystyrene plastic and oil. The hot homogeneous liquid blend of polystyrene plastic and oil can be fed directly to the refinery units.

Alternatively, a blend is prepared in a stable blend preparation unit where the hot homogeneous liquid blend is cooled to ambient temperature in a controlled manner to allow for easy storage and transportation. By using this method, a stable blend can be prepared at a facility away from a refinery and can be transported to a refinery unit. Then the stable blend is heated above the melting point of the plastic to feed to the refinery conversion unit. The stable blend is a physical mixture of micron-size plastic particles finely suspended in the aromatic-rich hydrocarbons, with the average particle size of the plastic particles of 10 micron to less than 100 microns. The mixture is stable, and the plastic particles do not settle or agglomerate upon storage for extended period.

What is meant by heating the blend to a temperature above the melting point of the polystyrene plastic is clear when a single plastic is used. However, if the waste plastic comprises more than one waste plastic, then the melting point of the plastic with the highest melting point is exceeded. Thus, the melting points of all polystyrene plastics must be exceeded. Similarly, if the blend is cooled below the melting point of the polystyrene plastic, the temperature must be cooled below the melting points of all polystyrene plastics comprising the blend.

Compared with a pyrolysis unit, these blend preparation units operate at a much lower temperature (˜500-600° C. vs. 200-290° C.). Thus, employing the present blend in conjunction with a refinery can provide a far more energy efficient process than a thermal cracking process such as pyrolysis.

The use of the present waste plastic/hydrocarbon blend further increases the overall hydrocarbon yield obtained from the waste plastic. This increase in yield is significant. The hydrocarbon yield using the present blend offers a hydrocarbon yield that can be as much as 98%. To the contrary, pyrolysis produces a significant amount of light product from the polystyrene plastic waste, about 10-30 wt. %, and about 5-10 wt. % of char. These light hydrocarbons are used as fuel to operate the pyrolysis plant, as mentioned above. Thus, the liquid hydrocarbon yield from the pyrolysis plant is at most 70-80%.

When the present blend is passed into the refinery units, such as a FCC unit, only a minor amount of offgas is produced. Refinery units use catalytic cracking processes that are different from the thermal cracking process used in pyrolysis. With catalytic processes, the production of undesirable light-end byproducts such as methane and ethane is minimized. Refinery units have efficient product fractionation and are able to utilize all hydrocarbon products streams efficiently to produce high value materials. Refinery co-feeding will produce only about 2% of offgas (H₂, methane, ethane, ethylene). The C₃ and C₄ streams are captured to produce useful products such as circular polymer and/or quality fuel products. Thus, the use of the present hydrocarbon/plastic blend offers increased hydrocarbons from the plastic waste, as well as a more energy efficient recycling process compared to a thermal process such as pyrolysis. The benefits of the present blend are significant when considering recycling waste plastic.

FIG. 2 illustrates a method for preparing a hot homogenous blend of polystyrene plastic and an aromatic-rich hydrocarbon feedstock which can be used for direct injection to a refinery unit. The preferred range of the plastic composition in the blend is about 1-20 wt. %., but can range from 1-10 wt. % in one embodiment, or 1-5 wt. % in another embodiment If high molecular weight polystyrene (average molecular weight of 150,000 to 500,000 or greater) waste plastic is used as the predominant waste plastic, e.g., at least 50 wt. %, then the amount of waste plastic used in the blend is more preferably about 10 wt. %. The reason being that the pour point and viscosity of the blend would be high. In one embodiment, the plastic can comprise polystyrene having an average molecular weight, M_{w}, in the range of 5,000 to 150,000. In another embodiment, the polystyrene plastic can comprise polypropylene having an average molecular weight, M_{w}, in the range of 50,000 to 250,000.

The preferred conditions for the hot homogeneous liquid blend preparation include heating the plastic above the melting point of the plastic while vigorously mixing with an aromatic-rich hydrocarbon feedstock. The preferred process conditions include heating to a 250-550° F. (120-290° C.) temperature, although always less than 550° F., with a residence time of 5-240 minutes at the final heating temperature, and 0-10 psig atmospheric pressure. This can be done in an open atmosphere as well as under an oxygen-free inert atmosphere.

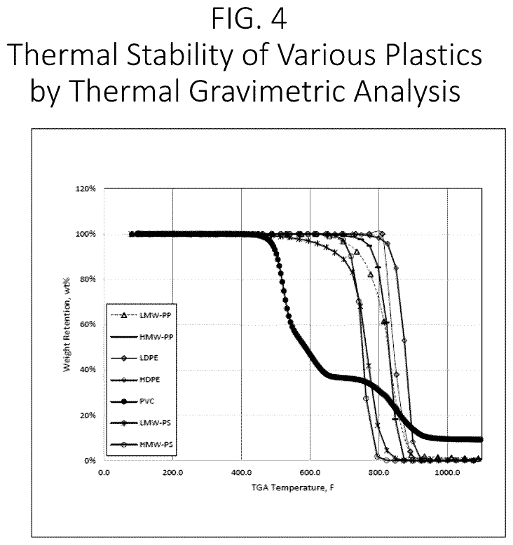

The hot homogeneous blend of polystyrene plastic melt and hydrocarbon feedstock is prepared by mixing a hydrocarbon feed and a polystyrene plastic together and then heating the mixture above the melting point of the polystyrene plastic, but generally not greater than 550° F. (290° C.), while thoroughly mixing. The heating temperature should not be so high as to begin breakdown of the polystyrene plastic. FIG. 4 graphically shows Thermal Gravimetric Analyses (TGA) results for various plastics, including polystyrene. The results indicates the thermal stabilities of the various plastics. Alternatively, the blend is prepared by melting the polystyrene plastic only and then adding the polystyrene plastic melt to the warm or hot hydrocarbon feedstock while thoroughly mixing. Alternatively, it is prepared by heating the hydrocarbon only to the temperature above the melting point of the polystyrene plastic and then adding solid polystyrene plastic slowly to the hot hydrocarbon liquid while thoroughly mixing the mixture and maintaining the temperature above the melting point of the plastic.

Referring to FIG. 2 of the Drawings, a stepwise preparation process of preparing the hot homogeneous liquid blend is shown. Mixed waste plastic is sorted to create post-consumer waste plastic 21 comprising polystyrene. The waste plastic is cleaned 22 and then mixed with a hydrocarbon feedstock oil 24 which is rich in aromatics in a hot blend preparation unit 23. After the mixing in 23, the homogeneous blend of the plastic and oil is recovered 25. Optionally a filtration device may be added (not shown) to remove any undissolved plastic particles or any solid impurities present in the hot liquid blend. The hot blend of the plastic and oil is then passed to a refinery conversion unit. Optionally, the blend of plastic and oil 25 can be combined with the refinery feedstock, such as vacuum gas oil (VGO) 20, and becomes a mixture of the plastic/oil blend and VGO, 26, which can then be passed to a refinery unit.

FIG. 3 illustrates a method for preparing a stable blend of plastic and oil. The stable blend is made in a stable blend preparation unit by a two-step process. The first step produces a hot, homogeneous liquid blend of plastic melt and hydrocarbon feedstock, the step is identical to the hot blend preparation described in FIG. 2. The preferred range of the plastic composition in the blend is about 1-20 wt. %. If high molecular weight polystyrene (average molecular weight of 150,000 to 500,000 or greater) waste plastic is used as the predominant waste plastic, e.g., at least 50 wt. %, then the amount of waste plastic used in the blend is more preferably about 10 wt. %. The reason being that the pour point and viscosity of the blend would be high.

The preferred conditions for the hot homogeneous liquid blend preparation include heating the plastic above the melting point of the plastic while vigorously mixing with an aromatic-rich hydrocarbon feedstock. The preferred process conditions include heating to a 250-550° F. (120-290° C.) temperature, with a residence time of 5-240 minutes at the final heating temperature, and 0-10 psig atmospheric pressure. This can be done in an open atmosphere as well as under an oxygen-free inert atmosphere.

In the second step, the hot blend is cooled down below the melting point of the plastic while continuously vigorously mixing with an aromatic-rich hydrocarbon feedstock, and then further cooling to a lower temperature, preferably ambient temperature, to produce a stable blend of the plastic and oil.

It has been found that the stable blend is an intimate physical mixture of polystyrene plastic and aromatic-rich hydrocarbon feedstock. The polystyrene plastic is in a “de-agglomerated” state. The polystyrene plastic maintains a finely dispersed state of solid particles in the aromatic-rich hydrocarbon feedstock at temperatures below the melting point of the plastic, and particularly at ambient temperatures. The blend is stable and allows easy storage and transportation. At a refinery, the stable blend can be heated in a preheater above the melting point of the plastic to produce a hot, homogenous liquid blend of the plastic and hydrocarbon. The hot liquid blend can then be fed to a refinery unit as a cofeed with conventional refinery feed.

In FIG. 3, further details of the stable blend preparation are shown. The stable blend is made in a stable blend preparation unit 100 by a two-step process. As shown, clean waste 22 is passed to the stable blend preparation unit 100. The selected plastic waste 22 is heated and mixed with a hydrocarbon feedstock oil 24 which is rich in aromatics. The plastic waste is heated above the melting point of the plastic to melt the plastic. The hydrocarbon feedstock is mixed with the heated plastic at 23. The mixing is often quite vigorous. The mixing and heating conditions can generally comprise heating at a temperature in the range of about 250-550° F. (120-290° C.), with a residence time of 5-240 minutes at the final heating temperature. The heating and mixing can be done in the open atmosphere or under an oxygen-free inert atmosphere. The result is a hot, homogenous liquid blend of plastic and oil 25. Optionally a filtration device may be added (not shown) to remove any undissolved plastic particles or any solid impurities present in the hot homogeneous liquid blend.

The hot blend 25 is then cooled below the melting point of the plastic while continuing the mixing of the plastic with the hydrocarbon feedstock 101. Cooling generally continues, usually to an ambient temperature, to produce a stable blend of the plastic and oil 102. At a refinery, the stable blend can be fed to a preheater, 29, which heats the blend above the melting point of the plastic to produce a mixture of plastic/oil blend, 26, which is then fed to a refinery conversion unit. Optionally other refinery feed such as VGO can be co-processed with the plastic/oil blend.

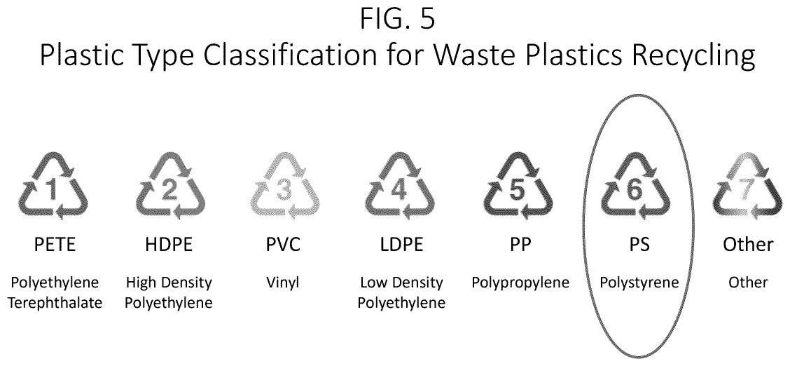

The present plastic starting material for use in the present blend comprises polystyrene (plastics recycle classification type 6). FIG. 5 depicts the plastic type classification for waste plastics recycling. Sorted plastic with polystyrene content over 60 wt. % is the preferred plastic source for this process of invention. Sorted plastic with polystyrene content over 80 wt. % is more preferred plastic source for this process of invention.

Proper sorting of waste plastics is very important in order to minimize contaminants such as N, Cl, and S. Plastics waste containing polyethylene terephthalate (plastics recycle classification type 1), polyvinyl chloride (plastics recycle classification type 3) and other polymers (plastics recycle classification type 7) need to be sorted out to less than 5%, preferably less than 1% and most preferably less than 0.1%. The present process can tolerate a moderate amount of polyethylene and polypropylene. High density polyethylene, low density polyethylene and polypropylene, (classification types 2, 4, and 5 respectively) and any combination these can also be present in a limited amount, preferably less than 30% most preferentially less than 20 wt. %.

The pre-sorted polystyrene is washed and shredded or pelleted to feed to a blend preparation unit. Washing of the polystyrene can remove metal contaminants such as sodium, calcium, magnesium, aluminum, and non-metal contaminants coming from other waste sources. Non-metal contaminants include contaminants coming from the Periodic Table Group IV, such as silica, contaminants from Group V, such as phosphorus and nitrogen compounds, contaminants from Group VI, such as sulfur compounds, and halide contaminants from Group VII, such as fluoride, chloride, and iodide. The residual metals, non-metal contaminants, and halides need to be removed to less than 50 ppm, preferentially less than 30 ppm and most preferentially to less than 5 ppm.

The hydrocarbon feedstock with which the polystyrene is blended is generally rich in aromatics. In one embodiment, the hydrocarbon feedstock oil with which the waste polystyrene plastic is blended comprises light cycle oil (LCO), medium cycle oil (MCO), heavy cycle oil (HCO), heavy gasoline, heavy reformate and/or an aromatic solvent derived from conventional petroleum refining. In one embodiment, the aromatic-rich hydrocarbon feedstock is derived from biofeedstock processing where the oxygen has been removed and the remaining liquid products are mostly hydrocarbons. It has been found that blending polystyrene with light cycle oil and/or an aromatic solvent derived from petroleum provides a very stale blend, and is thus preferred. Only the oil with high aromatic content can make a stable blend with polystyrene. Paraffinic feedstocks such as hydrotreated vacuum gas oil, paraffinic solvent, bio feedstock do not make stable blend with polystyrene.

More than one hydrocarbon feedstock can be used to optimize the blend properties. For example, the viscosity and pour point can be adjusted by adding different hydrocarbon feedstocks.

Optionally, solvents such as benzene, toluene, or xylene may be added to the blend to reduce the viscosity or pour point of the blend of polystyrene plastic and hydrocarbon feedstock for easier handling.

While not wanting to be bound by a theory, the present process prepares a stable blend that is an intimate physical mixture of polystyrene plastic and an aromatic-rich hydrocarbon feedstock for catalytic conversion in refinery units. The present process produces a stable blend of hydrocarbon feedstock and plastic wherein the plastic is in a “de-agglomerated” state. The polystyrene plastic maintains its state as “finely dispersed” solid particles in the aromatic-rich hydrocarbon feedstock at ambient temperature. This blend is stable and allows easy storage and transportation. At a refinery, the stable blend can be preheated above the melting point of the plastic to produce a hot, homogeneous liquid blend of plastic and hydrocarbon, and then the hot liquid blend is fed to a conversion unit. Then both the hydrocarbon feed and plastic are simultaneously converted in the conversion unit with typical refining catalysts containing zeolite(s) and other active components such as silica-alumina, alumina and clay.

The following examples are provided in order to further illustrate the present process. However, the examples are not meant to be limiting.

### EXAMPLES

### Example 1: Properties of Plastic Samples and Hydrocarbon Feedstocks for Stable Blend Preparations

Two polystyrene (PS) polymer samples with different molecular weights were used for the blend preparations. Their properties of polystyrene is shown in Table 1.

TABLE 1
Properties of Polystyrene (PS) Plastics Used

| | PS | PS |
|---|---|---|
| Form | Pellets | Pellets |
| Melt Index | 2.0-4.0 g/10 min | — |
| | (200° C./5 kg) | |
| Melting Point, ° C. | 270 | — |
| Transition Temp, ° C. | 95 | 123-128, softening |
| Density, g/mL at 25° C. | 1.04 | 1.06 |
| Average molecular weight, M_{w} | ~350,000 | ~35,000 |
| Number average molecular weight, Mₙ | ~170,000 | |

TABLE 2
Properties of LCO and aromatic blend for Blend Preparation

| | LCO | Aromatic 100 |
|---|---|---|
| | Hydrocarbon Feed #1 | Hydrocarbon Feed #2 |
| Specific Gravity | 0.956 | 0.872 |
| Carbon, wt. % | 90.50 | 89.90 |
| Hydrogen, wt. % | 9.50 | 10.10 |
| H/C Molar Ratio | 1.26 | 1.33 |
| Bromine Number | — | — |
| Total S, ppm | 900 | 0 |
| Total N, ppm | N/A | 0 |
| Ni, ppm | <0.2 | 0 |
| V, ppm | <0.2 | 0 |
| Simdist, ° F. | | |
| IBP (0.5%) | 235 | 297 |
| 5 wt. % | 405 | 325 |
| 10 wt. % | 441 | 327 |
| 30 wt. % | 490 | 330 |
| 50 wt. % | 541 | 336 |
| 70 wt. % | 607 | 344 |
| 90 wt. % | 689 | 355 |
| 95 wt. % | 718 | 362 |
| FBP (99.5%) | 786 | 376 |

Thermal Gravimetric Analysis (TGA) was conducted with the samples of PS and are compared to VGO as well as other plastics such as PVC, LDPE, HDPE and PP in FIG. 4. PS should be stable up to 550° F. so it can be blended without decomposition. The blending temperature should be less than 550° F., and preferably 500° F. or less.

### Example 2—Preparation of Stable Blends of Polystyrene Plastic With Hydrocarbon

Several blends of plastic were prepared by adding plastic pellets to a solvent for blending. The following procedure is used. The solvents tested are LCO and an aromatic solvent blend, and their properties are summarized in Table 2 above. At ambient temperature, the solvent was added to a beaker and heated with a heating mantle while stirring with a magnetic stirrer. The temperature was raised gradually to 270-400° F., and then pre-weighed plastic pellets (solids) were slowly added to the hot oil while stirring and heating. Visual observation was used to determine if the PS was soluble. If a homogeneous blend could be formed the stirred solution was then held at the final temperature for 60 additional minutes. Upon cooling to ambient temperature, the blend of the plastic and solvent showed the visual appearance of a waxy solid. Results of the solubility trials are shown in Table 3, and it was determined that LCO and the aromatic solvent blend are suitable to dissolve PS so that it can be delivered to a conversion unit such as a FCC.

To our surprise, polystyrene does not make stable blends with many kind of hydrocarbon solvents, unlike polyethylene and polypropylene. Blends of polystyrene with other hydrocarbon (hydrotreated vacuum gas oil (VGO), soybean oil (SBO), tallow, palm oil, and n-decane each) were attempted using the procedure above. Upon heating in these hydrocarbon, polystyrene pellets gradually melted in the hydrocarbon solvent. However, instead of forming an homogeneous liquid as in the cases with LCO and aromatic solvents, the plastic melt may not be completely miscible. Upon cooling, plastic phase was agglomerated and formed a large plastic solid piece.

Several mixtures bio feedstock and aromatic solvents were prepared. A 50:50 ratio of palm oil and aromatic solvent, 50:50 mixture of tallow and aromatic solvent, and 50:50 ratio of soybean oil and aromatic solvents were prepared. Plastic/bio feedstock/aromatic solvent blend preparations were attempted with 5 wt. % of low molecular weight polystyrene. To our surprise, none of these mixed solvents of bio feedstock and aromatic solvent was able to produce stable polystyrene and hydrocarbon blend. Our study showed that only aromatic solvent can make a stable blend with polystyrene.

The likely explanation for this is that in order to maintain stable blend of plastic and hydrocarbon mixture, the hydrocarbon solvent must have a very high degree of aromaticity. Aromatic solvent and LCO with abundant aromatic rings are able to solvate the polystyrene polymer strands and able to suspend them in the hydrocarbon solvent to form a stable blend at the ambient temperature.

TABLE 3
Solubility tests of low molecular weight polystyrene (LMW PS)
and high molecular weight polystyrene (HMW PS) in a
variety of potential FCC feeds.

| | 10 wt. % | 10 wt. % | 5 wt. % | 5 wt. % |
|---|---|---|---|---|
| Hydrocarbon Solvent | LMW-PS | HMW-PS | LMW PS | HMW PS |
| LCO | S | S | S | S |
| Aromatics | S | S | S | S |
| Hydrotreated VGO | U | | | |
| SBO | | | U | |
| Tallow | | | U | U |
| Palm | | | U | |
| n-C10 | | | U | |
| Palm/Arom. 50/50 | | | U | |
| Tallow/Arom 50/50 | | | U | |
| SBO/Arom. 50/50 | | | U | |

S = stable mixture formed with no apparent phase separation
U = unstable, no homogeneous blend formed, phase separation

### Catalytic Testing Procedure

To study the impact of processing polystyrene in a FCC unit, laboratory tests of a fluidized catalytic cracking (FCC) process were carried out with stable blends of PS. Two FCC catalysts were used for the study: a ZSM-5 FCC catalyst made of ZSM-5 zeolite (10-membered ring medium pore zeolite) and a USY FCC equilibrium catalyst (ECat) made of USY (12-membered ring large pore zeolite). In addition to FCC catalysts, an FCC additive containing magnesium oxide and calcium oxide was also tested.

The catalytic cracking experiments were carried out in an ACE (advanced cracking evaluation) Model C unit fabricated by Kayser Technology Inc. (Texas, USA). The reactor employed in the ACE unit was a fixed fluidized reactor with 1.6 cm ID. Nitrogen was used as fluidization gas and introduced from both bottom and top. The top fluidization gas was used to carry the feed injected from a calibrated syringe feed pump via a three-way valve. The experiments were carried out at atmospheric pressure and a temperature of 975° F. For each experiment a constant amount of 1.5-gram of feed was injected at the rate of 1.2 gram/min for 75 seconds. The cat/oil ratio was kept at 6. After 75 seconds of feed injection, the catalyst was stripped off by nitrogen for a period of 525 seconds. During the catalytic cracking and stripping process the liquid product was collected in a sample vial attached to a glass receiver, which was located at the end of the reactor exit and was maintained at −15° C. The gaseous products were collected in a closed stainless-steel vessel (12.6 L) prefilled with N₂ at 1 atm. Gaseous products were mixed by an electrical agitator rotating at 60 rpm as soon as feed injection was completed. After stripping, the gas products were further mixed for 10 mins to ensure homogeneity. The final gas products were analyzed using a refinery gas analyzer (RGA). After the completion of stripping process, the in-situ catalyst regeneration was carried out in the presence of air at 1300° F. The regeneration flue gas passed through a catalytic converter packed with CuO pellets (LECO Inc.) to oxidize CO to CO₂. The flue gas was then analyzed by an online IR analyzer located downstream of the catalytic converter. Coke deposited during the cracking process was calculated from the CO₂ concentrations measured by the IR analyzer.

Gaseous products, mainly C₁ through C₇ hydrocarbons, were resolved in an RGA. The RGA is a customized Agilent 7890B GC equipped with three detectors, a flame ionization detector (FID) for hydrocarbons and two thermal conductivity detectors for nitrogen and hydrogen. Gas products were grouped into dry gas (C₂-hydrocarbons and hydrogen), LPG (C₃ and C₄ hydrocarbons). Liquid products were weighed and analyzed in a simulated distillation GC (Agilent 6890) using ASTM D2887 method. The liquid products were cut into gasoline (C₅-430° F.), LCO (430-650° F., light cycle oil) and HCO (650° F.+, heavy cycle oil). Gasoline (C5+ hydrocarbons) in the gaseous products were combined with gasoline in the liquid products as total gasoline. Light ends in the liquid products (C₅−) were also subtracted from liquid products and added back to C₃ and C₄ species using some empirical distributions. Material balances were between 98% and 101% for most experiments.

Detailed hydrocarbon analysis (DHA) using Agilent 6890A (Separation Systems Inc., FL) were also performed on the gasoline portion of liquid products for PONA and octanes (RON and MON). DHA analysis on the gasoline portion in gaseous products were not performed. The DHA results, however, still provided valuable information to evaluate catalytic cracking product properties.

### Example 3—FCC Evaluation of LCO With MgO/CaO Catalyst (Base Case)

This example shows catalytic conversion of the LCO feed from Example 2 in the presence of a MgO/CaO FCC additive catalyst at three different reactor temperatures using the lab FCC testing unit described above. The results are summarized in Table 4. These results are the base cases to compare with the polystyrene/LCO co-processing cases in Example 4 (Table 5) to establish the impact of catalytic conversion of polystyrene in a fluidized catalytic cracking unit.

TABLE 4
Variable temperature cracking of LCO over calcium oxide and magnesium oxide
containing additive (Base Case)

| | Example 3-1 | Example 3-2 | Example 3-3 |
|---|---|---|---|
| Example | Base case | Base case | Base case |
| Feed | LCO | LCO | LCO |
| Catalyst | MgO/CaO additive | MgO/CaO additive | MgO/CaO additive |
| Temperature (F.) | 775 | 875 | 975 |
| Cat/Oil, wt/wt | 6 | 6 | 6 |
| Conversion [wt. %]* | 11.42 | 12.96 | 16.00 |
| Yield [wt. %] | | | |
| Coke | 4.67 | 5.94 | 7.40 |
| Dry Gas | 0.06 | 0.18 | 0.57 |
| LPG | 0.47 | 0.63 | 1.12 |
| Propylene | 0.16 | 0.24 | 0.45 |
| C4 Olefins | 0.25 | 0.32 | 0.54 |
| Gasoline (C5-430° F.) | 6.21 | 6.23 | 6.91 |
| Light Cycle Oil (430° F.-650° F.) | 75.03 | 72.43 | 69.26 |
| Heavy Cycle Oil (650° F.+) | 13.55 | 14.60 | 14.74 |
| Styrene, wt. % of feed | 0.00 | 0.01 | 0.01 |
| Gasoline Properties | | | |
| n-Paraffins [wt. %] | 3.41 | 2.05 | 3.17 |
| Isoparaffins [wt. %] | 3.96 | 3.06 | 2.94 |
| Naphthenes [wt. %] | 0.45 | 0.18 | 0.15 |
| Olefins [wt. %] | 1.25 | 0.85 | 1.07 |
| Aromatics [wt. %] | 87.20 | 91.14 | 90.19 |
| RON** | 85.40 | 85.18 | 84.61 |
| MON** | 74.64 | 73.71 | 73.39 |
| (RON + MON)/2** | 80.02 | 79.45 | 79.00 |

*Conversion-conversion of 430° F.⁺ fraction to 430° F.⁻.
**Octane number, (R + M)/2, was estimated from detailed hydrocarbon GC of FCC gasoline.

Conversion of LCO in the FCC unit is low, ranging from 11.4 to 16.0% with the reactor temperatures from 750° F. to 950° F., resulting in only 6.2 to 6.9 wt. % of gasoline range product. The yield of styrene is negligible in the product for all three base cases.

### Example 4—FCC Evaluation of Polystyrene/LCO Blend With MgO/CaO Catalyst

A 10/90 wt. % blend of polystyrene and LCO feed was evaluated with the FCC unit using MgO/CaO FCC additive catalyst at three different reactor temperatures and the results are summarized in Table 5. The impact of co-processing of polystyrene with LCO by the FCC process is compared with the corresponding base cases in Table 4.

TABLE 5
Variable temperature cracking of 10/90 wt. % blend of PS/LCO over
calcium oxide and magnesium oxide containing additive. Impact of
polystyrene in the feed and temperature.

| | Example 4-1 | Example 4-2 | Example 4-3 |
|---|---|---|---|
| Example | Invention | Invention | Invention |
| Feed | 10 wt. % | 10 wt. % | 10 wt. % |
| | LMW- | LMW- | LMW- |
| | PS-in-LCO | PS-in-LCO | PS-in-LCO |
| Catalyst | MgO/CaO | MgO/CaO | MgO/CaO |
| | additive | additive | additive |
| Temperature (F.) | 775 | 875 | 975 |
| Cat/Oil, wt/wt | 6 | 6 | 6 |
| Conversion [wt. %]* | 16.45 | 18.01 | 20.84 |
| Polystyrene Conversion, [wt. | 61.72 | 63.46 | 64.40 |
| %]** | | | |
| Yield [wt. %] | | | |
| Coke | 6.68 | 4.41 | 4.21 |
| Dry Gas | 0.07 | 0.17 | 0.62 |
| LPG | 0.44 | 0.63 | 1.09 |
| Propylene | 0.16 | 0.24 | 0.44 |
| C4 Olefins | 0.23 | 0.33 | 0.51 |
| Gasoline (C5-430° F.) | 9.26 | 12.80 | 14.93 |
| Light Cycle Oil (430° F.- | 70.06 | 67.90 | 65.25 |
| 650° F.) | | | |
| Heavy Cycle Oil (650° F.+) | 13.49 | 14.08 | 13.90 |
| Styrene, wt. % of Total Feed | 1.35 | 2.83 | 3.15 |
| Styrene Monomer Yield, wt. | 13.50 | 28.30 | 31.50 |
| % of PS in Total Feed*** | | | |
| Gasoline Properties | | | |
| n-Paraffins [wt. %] | 2.29 | 1.84 | 2.10 |
| Isoparaffins [wt. %] | 2.77 | 2.37 | 1.65 |
| Olefins [wt. %] | 0.66 | 0.64 | 0.97 |
| Naphthenes [wt. %] | 0.20 | 0.22 | 0.26 |
| Aromatics [wt. %] | 91.68 | 93.12 | 94.06 |
| Increase in Aromatics, Wt. % | 4.48 | 1.98 | 3.87 |
| RON**** | 91.28 | 94.87 | 95.32 |
| MON**** | 79.64 | 82.68 | 82.92 |
| (RON + MON)/2**** | 85.46 | 88.78 | 89.12 |

*Conversion-conversion of 430° F.⁺ fraction to 430° F.⁻
**Polystyrene conversion is calculated by subtracting the contribution from LCO and normalizing to 100% polystyrene feed, assuming conversion and yields blend linearly. For example, at 775 F., the polystyrene conversion is calculated as the conversion on PS\LCO blend which is 16.45 minus 90% of neat LCO conversion which is 11.42 and then divided by 10%.
***Styrene monomer yield is the wt. % yield based on the polystyrene in the total feed.
****Octane number, (R + M)/2, was estimated from detailed hydrocarbon GC of FCC gasoline.

Upon addition of polystyrene in the LCO feed to the FCC unit (Example 3-1 vs 4-1; Example 3-2 vs 4-2 Example 3-3 vs 4-3), the conversion increased by about 5 wt. %. As calculated in Table 5, the polystyrene conversion is more than 60%, e.g., more than 60% of polystyrene has been converted to products that boil below 430 F such as gasoline, LPG and light gases. Styrene yield based on polystyrene in the total feed ranged from 13.50 to 31.50%. The detailed composition analysis of the gasoline boiling range products showed increases in aromatics content upon addition of polystyrene in the feed. The results indicate that good amount of polystyrene has been converted back to styrene monomer and other high-value aromatic compounds.

### Example 5—FCC Evaluation of Polystyrene/LCO Blend With Zeolite Catalysts

Pure LCO feed was evaluated with the FCC unit using FCC catalysts (USY catalyst and ZSM-5 catalyst) as the base cases and the results are summarized in Table 6. A 10/90 wt. % blend of polystyrene and LCO feed was evaluated with the same catalysts to study the impact of co-processing of polystyrene with LCO and the results were compared with the corresponding base cases in Table 6.

TABLE 6
Cracking of Polystyrene/LCO Blend over ECAT and ZSM-5, Impacts of
Polystyrene in the Feed and Catalyst (USY and ZSM-5 Catalysts)

| | Example 5-1 | Example 5-2 | Example 5-3 | Example 5-4 |
|---|---|---|---|---|
| Example | Base case | Invention | Base case | Invention |
| Feed | LCO | LCO-10 wt. % | LCO | LCO-10 wt. % |
| | | LMW-PS | | LMW-PS |
| Catalyst | ECAT | ECAT | ZSM-5 | ZSM-5 |
| Conversion [wt. %] | 34.14 | 44.45 | 15.91 | 23.68 |
| Polystyrene Conversion, wt. % | NA | Complete** | Base Case | 93.61 |
| Temperature (F.) | 975 | 975 | 975 | 975 |
| Cat/Oil, wt/wt | 6 | 6 | 6 | 6 |
| Yield [wt. %] | | | | |
| Coke | 8.28 | 8.74 | 1.02 | 1.04 |
| Dry Gas | 2.18 | 2.03 | 1.36 | 1.41 |
| LPG | 6.60 | 5.99 | 5.12 | 4.35 |
| Propylene | 2.21 | 2.17 | 2.53 | 2.19 |
| C4 Olefins | 1.90 | 1.76 | 1.69 | 1.47 |
| Gasoline (C5-430° F.) | 17.07 | 27.69 | 8.41 | 16.89 |
| Light Cycle Oil (430° F.-650° F.) | 53.63 | 45.39 | 67.99 | 61.57 |
| Heavy Cycle Oil (650° F.+) | 12.23 | 10.17 | 16.10 | 14.76 |
| Styrene, wt. % of Total Feed | 0.00 | 0.24 | 0.00 | 1.69 |
| Styrene Monomer Yield*, Wt. | Base case | 2.40 | Base case | 16.9 |
| % of PS in Total Feed | | | | |
| Gasoline Properties | | | | |
| n-Paraffins [wt. %] | 1.14 | 0.79 | 3.08 | 2.25 |
| Isoparaffins [wt. %] | 8.97 | 4.24 | 6.59 | 3.35 |
| Olefins [wt. %] | 3.29 | 1.27 | 2.04 | 0.43 |
| Naphthenes [wt. %] | 1.33 | 1.82 | 0.36 | 2.10 |
| Aromatics [wt. %] | 83.73 | 91.81 | 85.17 | 90.89 |
| Increase in Aromatics, Wt. % | Base case | 8.08 | Base case | 5.72 |
| RON | 89.61 | 102.87 | 83.85 | 101.89 |
| MON | 78.94 | 92.79 | 72.92 | 91.63 |
| (RON + MON)/2 | 84.27 | 97.83 | 78.39 | 96.76 |

*Styrene monomer yield is the wt. % yield based on the polystyrene in the total feed.
**Calculated polystyrene conversion is over 100%, which means all polystyrene in the feed has been completely converted to products boil below 430° F.

Upon addition of polystyrene in the LCO feed to the USY catalyst in the FCC unit (Example 5-1 vs. 5-2), the conversion increased by 10.3 wt. %, which gives complete conversion of polystyrene to products boil below 430 F. Other than the shifts of LCO and gasoline yields, the overall yields (coke, light gas, LPG, HCO) are comparable to the base case. The yield of styrene produced was 2.4 wt. % based on the polystyrene in the feed. The detailed composition analysis of the gasoline boiling range products showed 8.08 wt. % increases in aromatics content upon addition of polystyrene in the feed. These results suggest that polystyrene is fully converted in the FCC unit and produced mostly gasoline boiling range, single-ring aromatic hydrocarbons including styrene which are value-added products.

Upon addition of polystyrene in the LCO feed to the ZSM-5 catalyst in the FCC unit (Example 5-3 vs. 5-4), the conversion increased by 7.7 wt. %, which gives a conversion of 93.6 wt. % for the polystyrene. Other than the shifts of LCO and gasoline yields, the overall yields (coke, light gas, LPG, HCO) are comparable to the base case. The yield of styrene produced was 16.9 wt. % based on the polystyrene in the feed. The detailed composition analysis of the gasoline boiling range products showed 5.72 wt. % increases in aromatics content upon addition of polystyrene in the feed. Like the results on USY, the results on ZSM-5 also suggest that polystyrene is fully converted on ZSM-5 under FCC conditions and produced mostly gasoline boiling range, single-ring aromatic hydrocarbons including styrene which are value-added products.

### Example 6—FCC Evaluation of Polystyrene/Aromatic Solvent Blend With Zeolite Catalysts

Neat aromatic solvent feed was evaluated in the lab FCC unit using FCC catalysts (USY catalyst and ZSM-5 catalyst) as the base cases and the results are summarized in Table 7. A 10/90 wt. % blend of polystyrene and aromatic solvent feed was evaluated with the same catalysts to study the impact of co-processing of polystyrene with aromatic solvent and the results were compared with the corresponding base cases in Table 7.

TABLE 7
Cracking of Polystyrene/Aromatic Solvent Blend over ECAT and ZSM-5, Impacts
of Polystyrene in the Feed and Catalyst (USY and ZSM-5 Catalysts)

| | Example 6-1 | Example 6-2 | Example 6-3 | Example 6-4 |
|---|---|---|---|---|
| Example | Base case | Invention | Base case | Invention |
| Feed | Aromatic | Aromatics- | Aromatic | Aromatics- |
| | solvent | 10% LMW-PS | solvent | 10% LMW-PS |
| Catalyst | ECAT | ECAT | ZSM-5 | ZSM-5 |
| Temperature (F.) | 975 | 975 | 975 | 975 |
| Cat/Oil, wt/wt | 6 | 6 | 6 | 6 |
| Conversion [wt. %] | 93.62 | 96.00 | 96.50 | 97.48 |
| Yield [wt. %] | | | | |
| Coke | 2.75 | 4.80 | 0.32 | 0.85 |
| Dry Gas | 1.30 | 1.28 | 2.10 | 1.57 |
| LPG | 1.88 | 1.52 | 2.31 | 1.68 |
| Propylene | 1.05 | 0.87 | 1.66 | 1.18 |
| C4 Olefins | 0.21 | 0.19 | 0.47 | 0.38 |
| Gasoline (C5-430° F.) | 87.71 | 88.41 | 91.78 | 93.40 |
| Light Cycle Oil (430° F.-650° F.) | 5.06 | 3.02 | 2.73 | 1.80 |
| Heavy Cycle Oil (650° F.+) | 1.32 | 0.98 | 0.77 | 0.71 |
| Styrene, wt. % of Total Feed | 0.00 | 0.39 | 0.00 | 3.00 |
| Styrene Monomer Yield*, Wt. | 0.00 | 3.90 | 0.00 | 30 |
| % of PS in Total Feed | | | | |
| Gasoline Properties | | | | |
| n-Paraffins [wt. %] | 1.36 | 0.12 | 0.23 | 0.10 |
| Isoparaffins [wt. %] | 2.54 | 2.33 | 0.80 | 1.49 |
| Olefins [wt. %] | 8.53 | 2.49 | 2.24 | 0.25 |
| Naphthenes [wt. %] | 4.32 | 3.57 | 1.75 | 2.11 |
| Aromatics [wt. %] | 83.23 | 91.42 | 95.10 | 96.02 |
| Increase in Aromatics, Wt. % | Base case | 8.19 | Base case | 0.92 |
| RON | 101.33 | 110.22 | 110.90 | 112.29 |
| MON | 92.60 | 97.38 | 99.12 | 99.43 |
| (RON + MON)/2 | 96.97 | 103.80 | 105.01 | 105.86 |

*Styrene monomer yield is the wt. % yield based on the polystyrene in the total feed.

Upon addition of polystyrene in the aromatic solvent feed to the USY catalyst in the FCC unit (Example 6-1 vs. 6-2), slight increase in conversion and shifts in the overall yields (coke, light gas, LPG, gasoline, LCO, HCO) are observed compared to the base case which already has very high conversion indicating polystyrene is fully converted in the FCC unit. The yield of styrene produced was 3.9 wt. % based on the polystyrene in the feed. The detailed composition analysis of the gasoline boiling range products showed 8.19 wt. % increases in aromatics content upon addition of polystyrene in the feed.

Upon addition of polystyrene in the aromatic solvent feed to the ZSM-5 catalyst in the FCC unit (Example 6-3 vs. 6-4), slight shifts in the overall yields (coke, light gas, LPG, gasoline, LCO, HCO) are observed compared to the base case which already has near complete conversion indicating polystyrene is also fully converted in the FCC unit. The yield of styrene produced was 30 wt. %. The detailed composition analysis of the gasoline boiling range products showed slight increase of 0.92 wt. % in aromatics content upon addition of polystyrene in the feed. The base case already has a very high aromatic content of 95 wt. %.

The foregoing results show that hydrocarbon feedstocks such as LCO, heavy gasoline, heavy reformate and aromatic solvent blends can be successfully used to prepare a blend with polystyrene, which blend can then be converted in a refinery conversion unit. The foregoing conversion reaction results further show that the results can be controlled by appropriate selection of the catalyst used in the conversion reactions.

As used in this disclosure the word “comprises” or “comprising” is intended as an open-ended transition meaning the inclusion of the named elements, but not necessarily excluding other unnamed elements. The phrase “consists essentially of” or “consisting essentially of” is intended to mean the exclusion of other elements of any essential significance to the composition. The phrase “consisting of” or “consists of” is intended as a transition meaning the exclusion of all but the recited elements except for only minor traces of impurities.

As those skilled in the art will appreciate, numerous modifications and variations of the present invention are possible considering these teachings, and all such are contemplated hereby. For example, in addition to the embodiments described herein, the present invention contemplates and claims those inventions resulting from the combination of features of the invention cited herein and those of the cited prior art references which complement the features of the present invention. Similarly, it will be appreciated that any described material, feature, or article may be used in combination with any other material, feature, or article, and such combinations are considered within the scope of this invention.

All of the publications cited in this disclosure are incorporated by reference herein in their entireties for all purposes.

What is claimed is:

1. A blend of a aromatic-rich hydrocarbon feedstock and 1-20 wt. % of polystyrene, based on the weight of the blend.

2. The blend of claim 1, wherein the amount of polystyrene in the blend comprises from 1-10 wt. % of the blend.

3. The blend of claim 1, wherein the polystyrene comprises low molecular weight polystyrene.

4. The blend of claim 1, wherein the polystyrene comprises high molecular weight polystyrene.

5. The blend of claim 1, wherein the polystyrene comprises polystyrene having an average molecular weight, Mw, in the range of 5,000 to 50,000.

6. The blend of claim 1, wherein the polystyrene comprises polystyrene having an average molecular weight, Mw, in the range of 150,000 to 500,000.

7. The blend of claim 1, wherein the polystyrene comprises a mixture of high and low molecular weight polystyrene.

8. The blend of claim 1, wherein the aromatic-rich hydrocarbon feedstock comprises an aromatics content greater than 50 wt. %, and optionally the hydrocarbon feedstock comprises 50% to 99% of 1-ring, 2-ring and 3-ring aromatics.

9. The blend of claim 1, wherein the aromatic-rich hydrocarbon feedstock comprises light cycle oil, heavy gasoline, heavy reformate, an aromatic solvent blend or bio-derived aromatic oil or a mixture thereof.

10. The blend of claim 1, where the aromatic-rich hydrocarbon feedstock comprises recycled FCC heavy cut gasoline or heavy reformate from naphtha reforming.

11. The blend of claim 1, where the aromatic-rich hydrocarbon feedstock comprises medium cycle oil and heavy cycle oil.

12. The blend of claim 1, wherein the blend is at a temperature below the melting point of the polystyrene, and the polystyrene in the blend comprises finely dispersed micron size particles.

13. The blend of claim 1, wherein the temperature of the blend is above the melting point of the polystyrene.

14. The blend of claim 1, wherein the blend comprises waste polystyrene.

15. A process for preparing a stable blend of polystyrene and a hydrocarbon feedstock comprising:
(a) mixing a hydrocarbon feedstock and polystyrene comprising polystyrene together and heating the mixture above the melting point of the polystyrene, but less than 550° F., while mixing; and
(b) cooling the polystyrene melt and hydrocarbon feedstock liquid blend to a temperature below the melting point of the polystyrene.

16. The process of claim 15, wherein the cooling in (b) is conducted together with continuous stirring.

17. The process of claim 15, wherein the heating is conducted at a temperature of 250-550° F. (120-290° C.) with a residence time of 5-240 minutes at a final heating temperature.

18. The process of claim 15, wherein the cooling is continued until ambient temperature is reached.

19. A process for converting polystyrene comprising:
(a) selecting plastics containing polystyrene;
(b) preparing a blend of a hydrocarbon feedstock and the polystyrene plastic, with the blend comprising about 20 wt. % or less of the polystyrene plastic; and
(c) passing the blend to a catalytic conversion unit.

20. The process of claim 19, wherein the hydrocarbon feedstock comprises light cycle oil.

21. The process of claim 19, wherein the hydrocarbon feedstock comprises an aromatic solvent.

22. The process of claim 19, wherein the catalytic conversion unit comprises a FCC unit, a hydrocracker, or a hydrotreating unit.
